(19) United States
(12) Patent Application Publication
(10) Pub. No.: US 2013/0118799 A1
(43) Pub. Date: May 16, 2013

(54) WIRE HARNESS PROTECTING STRUCTURE

(71) Applicants: Jin Watanabe, Toyota-shi (JP); Shigeki Mori, Toyota-shi (JP)

(72) Inventors: Jin Watanabe, Toyota-shi (JP); Shigeki Mori, Toyota-shi (JP)

(73) Assignee: YAZAKI CORPORATION, Tokyo (JP)

(21) Appl. No.: 13/810,293

(22) PCT Filed: Jul. 7, 2011
(86) PCT No.: PCT/JP2011/065619

§ 371 Date: Jan. 15, 2013

(30) Foreign Application Priority Data
Jul. 16, 2010 (JP) 2010-161711

(51) Int. Cl. H02G 3/04

(52) U.S. Cl. CPC H02G 3/0406
USPC 174/72 A

(57) ABSTRACT

The wire harness protecting structure serves to protect predetermined parts of the wire harness 11 from an interference of other members. The wire harness protecting structure includes protecting members 15 which cover outer peripheries of the wire harness 11 in the predetermined parts and a fixing adhesive tape 21 fixed in such a way that a starting end part 17 is wound on the wire harness 11 and fixed thereto, the fixing adhesive tape is wound on the outer peripheries of the protecting members 15 to fix the protecting members 15, and then, a terminal end part 19 wound and fixed on the wire harness 11 opposite to the starting end part 17 with the protecting members 15 sandwiched between them.

### TECHNICAL FIELD

The present invention relates to a wire harness protecting structure which protects a predetermined parts of a wire harness from an interference of other members.

### BACKGROUND ART

Since the wire harness is attached to a vehicle body, the wire harness is supposed to come into contact with a peripheral member of a vehicle body laying passage so that au outer jacket may be rubbed thereby due to a vibration. Thus, for the purpose of protecting the wire harness, a corrugated tube, a tube and a vinyl sheet are occasionally attached to an outer periphery of the wire harness (for instance, see patent literature 1). As shown in FIG. 6, a corrugated tube 500 has a bellows shaped cylindrical form and slits formed along an axial direction thereof. In order to attach the corrugated tube 500 to the wire harness 501, the slits are forcibly opened to cover the outer periphery of the wire harness 501 therewith. Then, both terminals of the corrugated tube 500 are fixed to the wire harness 501 by a adhesive tape so as not to be displaced.

Ordinarily, a plurality of interfering parts 503 where the wire harness 501 comes into contact with peripheral members are frequently dotted in the form of spots along a predetermined length L of the wire harness 501. In this case, when the corrugated tube 500 is divided into parts respectively for the interfering parts 503, the number of parts is increased or the number of works is increased. Accordingly, in a usual wire harness protecting structure, a long corrugated tube 500 is used which can cover together the plurality of interfering parts 503.

### LITERATURE OF RELATED ART

### Patent Literature

Patent Literature 1: JP-A-2006-296166

### SUMMARY OF THE INVENTION

### Problems that the Invention is to Solve

However, in the usual wire harness protecting structure, since the lengthy corrugated tube 500 which covers the plurality of interfering parts 503 is used, other parts than the interfering parts 503 are useless. Since the interfering parts 503 have various numbers and spaces, a plurality of kinds of corrugated tubes 500 having different entire lengths need to be prepared. Accordingly, a working property is deteriorated, a management of parts is complicated, and a member cost and a production cost are high. Further, an entire part of the wire harness is disadvantageously lightened.

The present invention is devised by considering the above-described circumstance and it is an object of the present invention to provide a wire harness protecting structure which can reduce a quantity and kinds of protecting members, lower a cost and lighten an entire part of a wire harness.

### Means for Solving the Problems

The above-described object of the present invention can be achieved by below-described structures.

(1) A wire harness protecting structure which protects a predetermined part of a wire harness from an interference of other member, comprising a protecting member which cover an outer periphery of the wire harness in the predetermined part, and a fixing adhesive tape in which a starting end part thereof is wound and fixed on the wire harness, the fixing adhesive tape is wound on the outer periphery of the protecting member so as to fix the protecting member, and then, a terminal end part thereof is wound and fixed on the wire harness in an opposite side to the starting end part with the protecting member sandwiched between the starting end part and the terminal end part.

(2) A wire harness protecting structure according to the above-described (1), wherein the protecting member is respectively provided at plurality of predetermined parts.

(3) A wire harness protecting structure according to the above-described (1) or (2), wherein the protecting member is formed with a protecting adhesive tape.

(4) A wire harness protecting structure according to the above-described (3), wherein the protecting adhesive tape is thicker than the fixing adhesive tape.

(5) A wire harness protecting structure according to the above-described (3), wherein the protecting adhesive tape has a plurality of tapes laminated.

(6) A wire harness protecting structure according to the above-described (4), wherein the protecting adhesive tape has a plurality of tapes laminated.

According to the wire harness protecting structure of the above-described (1), as compared with the protecting structure that the protecting member such as the lengthy corrugated tube, the tube and the vinyl sheet is usually provided over the plurality of interfering parts, the protecting members are provided in the forms of spots respectively for the interfering parts. Accordingly, an unnecessary part provided only for connecting the interfering parts together is eliminated, so that a quantity and kinds (kinds of different lengths) of the protecting members can be suppressed to a minimum as necessary as possible. Namely, the protecting member can be reduced more by the quantity of the unnecessary part to be eliminated. Further, when one kind of the protecting member used in the forms of spots is merely provided, the plurality of interfering parts located at various pitches can be individually met. Thus, a plurality of kinds of the protecting members having the different lengths for protecting the interfering parts together do not need to be prepared.

According to the wire harness protecting structure of the above-described (2), as compared with the protecting structure that the protecting member such as the lengthy corrugated tube, the tube and the vinyl sheet is usually provided over the plurality of interfering parts, the protecting members are provided in the forms of spots respectively for the interfering parts and fixed in the same forms. Thus, the plurality of interfering parts can be protected together by one kind of protecting member.

According to the wire harness protecting structure of the above-described (3), both the protecting member and the fixing adhesive tape are formed with the adhesive tape. Thus, an operation and a management of parts are easy. When the same adhesive tape is used for the protecting adhesive tape and the fixing adhesive tape, the operation and the management of the parts are easier.

According to the wire harness protecting structure of the above-described (4), strength of the protecting adhesive tape can be easily ensured. Further, when the protecting adhesive tape has such a thickness as to generate a necessary strength, the protecting adhesive tape may be wound once to make a fixing operation easy. Further, when the protecting adhesive tape is thicker than the fixing adhesive tape, the number of windings may be reduced to make the operation easy.

According to the wire harness protecting structure of the above-described (5) and (6), when the plurality of protecting adhesive tapes are laminated or piled to increase a thickness, is obtained the same mechanical strength as that of a usually used protecting member such as the usual corrugated tube, the tube and the vinyl sheet. Here, a lamination of a plurality of tapes includes both a structure that the adhesive tape is wound a plurality of times and a structure that a plurality of adhesive tapes having predetermined forms are laminated and stuck. According to the structure of the plurality of tapes laminated, a protecting performance having the same strength can be easily obtained.

### BRIEF DESCRIPTION OF THE DRAWING

FIG. 1 is a perspective view of an external appearance of a wire harness protecting structure according to a first exemplary embodiment of the present invention.

FIG. 2 is a perspective view of a wire harness before a fixing adhesive tape is wound thereon.

FIG. 3 is a sectional view of the wire harness having a part covered with a protecting member.

FIG. 4 is a perspective view of a protecting adhesive tape laminated in three layers.

FIG. 5 is a sectional view of main parts of a wire harness protecting structure according to a second exemplary embodiment of the present invention.

FIG. 6 is a perspective view of a usual wire harness protecting structure.

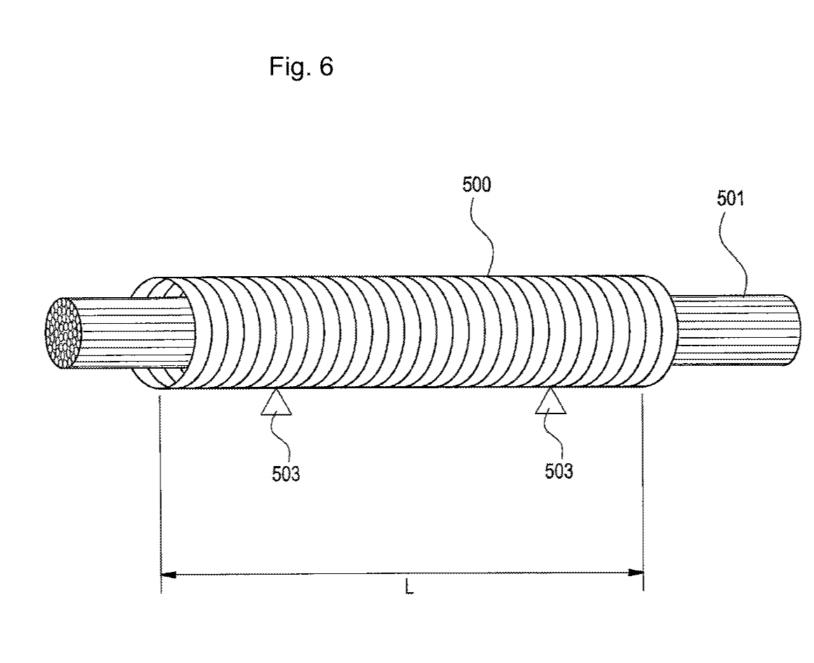

### MODE FOR CARRYING OUT THE INVENTION

Now, an exemplary embodiment of the present invention will be described below by referring to the drawings.

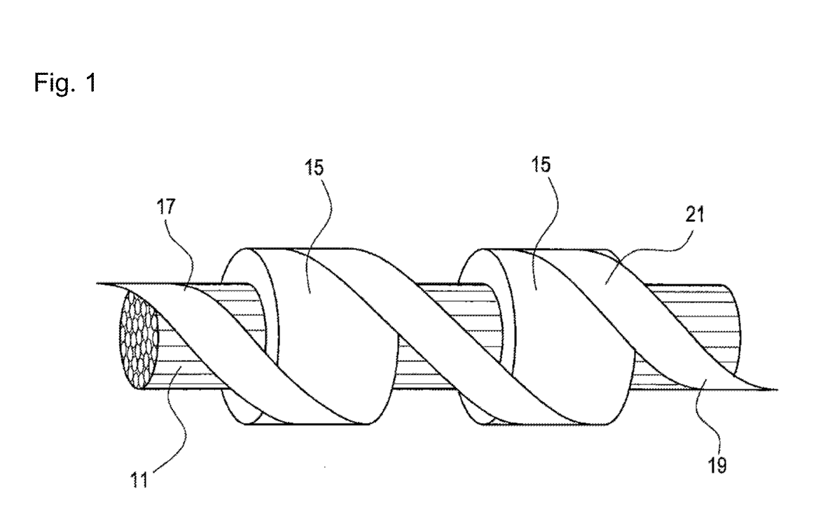

FIG. 1 is a perspective view of an external appearance of a wire harness protecting structure according to a first exemplary embodiment of the present invention.

The wire harness protecting structure serves to protect a predetermined part of a wire harness 11 from an interference of other members. The wire harness 11 may be a single wire or a bundle of a plurality of wires. The wire harness protecting structure includes protecting members 15 which cover outer peripheries of the wire harness 11 in predetermined parts and a fixing adhesive tape 21 which fixes the protecting members 15.

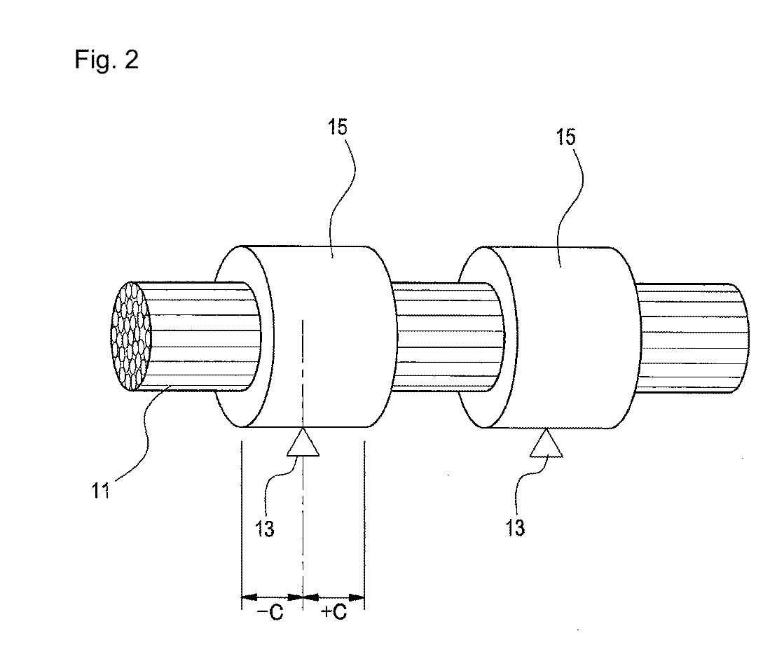

FIG. 2 is a perspective view of the wire harness before the fixing adhesive tape is wound thereon.

The wire harness protecting structure may have one predetermined part or a plurality of predetermined parts to be protected. In this exemplary embodiment, an example is exemplified which has the plurality of predetermined parts (two parts). Here, the predetermined parts mean ranges of outer peripheries of the wire harness 11 including a constant tolerance dimension±C in the axial direction of the wire harness 11 with respect to interfering parts 13 as centers as shown in FIG. 2 with which other members come into contact.

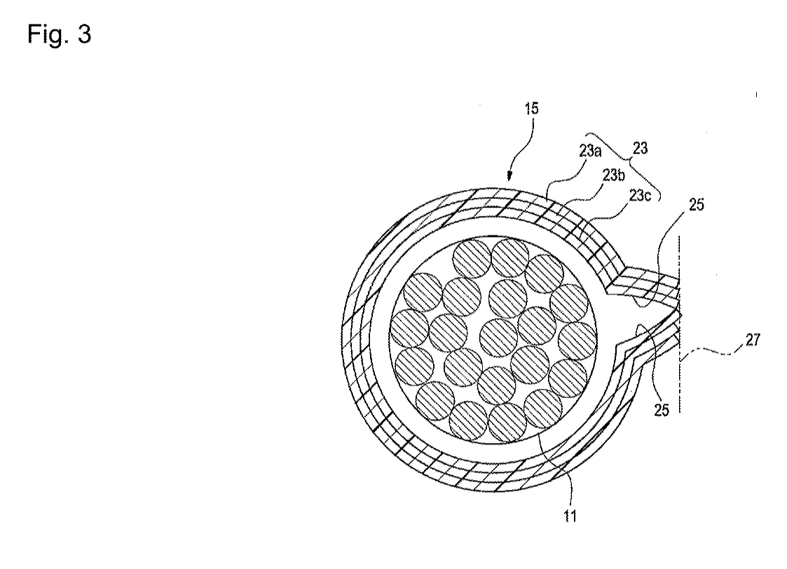

As for the protecting member 15, are exemplified as a member, a adhesive vinyl tape (refer it simply to as a “adhesive tape”.), a vinyl sheet for an outer jacket, a sponge sheet, a metallic braided wire, a tube, or the like. The vinyl sheet and the tube are formed with the same members as those used hitherto, however, when the vinyl sheet and the tube are used in the present exemplary embodiment, they are not long, but short so as to be arranged in the form of spots only in the predetermined parts. The members of them can be set in accordance with the members or forms of mate interfering members. In the present exemplary embodiment, for the protecting members 15, a protecting adhesive tape 23 (see FIG. 3) as the adhesive tape is used.

Since the protecting member 15 is formed with the protecting adhesive tape 23, both the protecting member 15 and the fixing adhesive tape 21 are formed with the adhesive tape. Thus, a winding operation and a management of parts are easy. When the same adhesive tape is used for the protecting adhesive tape 23 and the fixing adhesive tape 21, the operation and the management of the parts are easier.

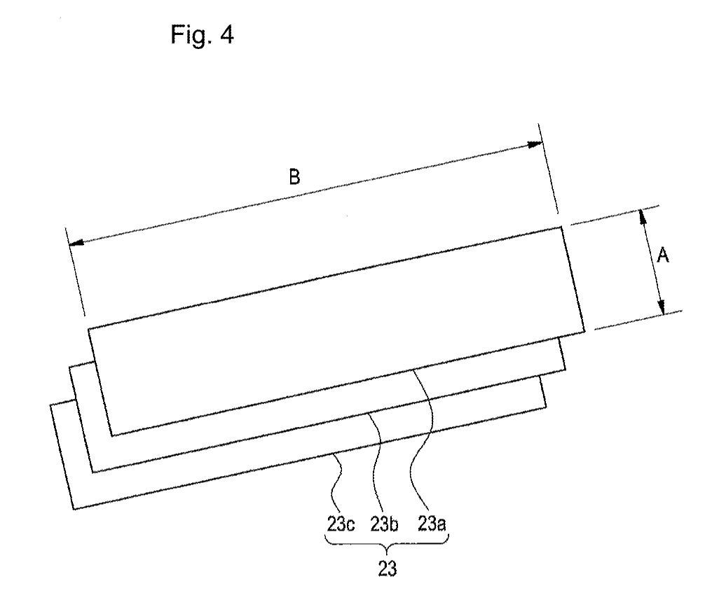

FIG. 3 is a sectional view of the wire harness having a part covered with the protecting member. FIG. 4 is a perspective view of the protecting adhesive tape laminated in three layers.

The protecting adhesive tape 23 may have a structure that a plurality of tape pieces are laminated and stuck. Namely, as shown in FIG. 4, a plurality of adhesive tape pieces 23a, 23b and 23c which are cut to a predetermined width A and a length B are laminated and stuck to one another with respect to the interfering part 13 as the center. When the plurality of adhesive tape pieces are laminated or piled to have a predetermined thickness, the protecting adhesive tape 23 can obtain the same mechanical strength as that of a usual corrugated tube, a tube and a vinyl sheet. That is, when the protecting adhesive tape 23 has such a predetermined thickness as to obtain the mechanical strength, the protecting adhesive tape 23 can be used as the protecting member.

As a three-piece laminated structure that the protecting adhesive tape 23 of a predetermined form is stuck as a lamination of three tape pieces, a stuck structure may be provided, as shown in FIG. 3, that a direction of width A of the protecting adhesive tape 23 having the three tape pieces laminated is set as a length of the protecting member 15 in an axial direction (a longitudinal direction in FIG. 2), a direction of length B of the protecting adhesive tape 23 is wound on a circumferential direction of the wire harness 11 and adhesive surfaces 25 at both ends are bonded to each other. In this case, an excess part can be removed by a cutting line 27 to make the operation easy. Further, the excess part may be further wound on a peripheral surface of the protecting adhesive tape 23 and fixed thereto.

According to the three-piece laminated structure, as compared with a structure that one adhesive tape is wound threefold, the number of windings does not need to be counted, so that the windings can be simply managed.

As the protecting member 15, the protecting adhesive tape 23 thicker than the fixing adhesive tape 21 may be used. Thus, the strength of the protecting member 15 can be easily ensured. When the protecting adhesive tape 23 has such a thickness as to generate a necessary strength, the protecting adhesive tape may be wound once to make a fixing operation easy. Further, when the protecting adhesive tape 23 is thicker than the fixing adhesive tape 21, the number of windings thereof may be reduced to make the operation easy.

Further, in the above-described stuck structure, the direction of length B of the protecting adhesive tape 23 is wound on the circumferential direction of the wire harness 11 and the adhesive surfaces 25 at both the ends are bonded to each other. However, an ordinary winding structure may be formed that the protecting adhesive tape 23 having the three tape pieces laminated shown in FIG. 4 is spirally wound on the outer periphery of the wire harness 11.

In the wire harness protecting structure, the fixing adhesive tape 21 is wound on the wire harness 11 provided with the protecting members 15. In the fixing adhesive tape 21, a starting end part 17 shown in FIG. 1 is wound on the wire harness 11 and fixed thereto. The fixing adhesive tape 21 is wound on the outer peripheries of the protecting members 15 respectively to fix the protecting members 15. Then, a terminal end part 19 is wound and fixed on the wire harness 11 opposite to the starting end part 17 with the protecting members 15 sandwiched between them.

Accordingly, the protecting members 15 respectively provided at the plurality of parts are wound by the continuous fixing adhesive tape 21 and integrally fixed in the same forms. Thus, as compared with the protecting structure that the protecting member 15 such as the lengthy corrugated tube, the tube and the vinyl sheet is usually provided over the plurality of interfering parts, the protecting members 15 are provided in the forms of spots respectively for the interfering parts and fixed in the same forms. Accordingly, the plurality of arbitrary interfering parts 13 can be protected together by the one kind of protecting members 15.

Now, a second exemplary embodiment of the present invention will be described below.

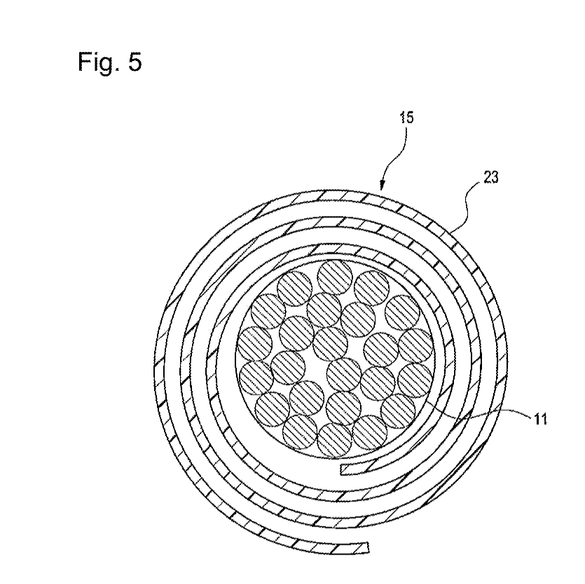

FIG. 5 is a sectional view of main parts of a wire harness protecting structure according to the second exemplary embodiment of the present invention.

In the wire harness protecting structure according to the present exemplary embodiment, the same tape as a fixing adhesive tape 21 is used for a protecting adhesive tape 23. In a winding structure, one protecting adhesive tape 23 is wound three times to form a protecting member 15.

In the wire harness protecting structure according to this exemplary embodiment, since the protecting member 15 can be formed by using only the same adhesive tape as the fixing adhesive tape 21, and the protecting adhesive tape 23 and the fixing adhesive tape 21 are used in the same winding operations, the operation can be greatly simplified.

In the winding structure that the one protecting adhesive tape 23 is wound three times, it is not necessarily eliminated to use the protecting adhesive tape 23 thicker than the fixing adhesive tape 21. When the protecting tape 23 which is wound three times is thick, strength of the protecting member 15 is easily ensured. Further, when the protecting adhesive tape 23 has such a thickness as to generate a necessary strength, the protecting adhesive tape may be wound once to make a fixing operation easy. Further, when the protecting adhesive tape 23 is a little thicker than the fixing adhesive tape 21, the number of windings thereof may be reduced to make the operation easy.

As described above, in the wire harness protecting structures according to the first and second exemplary embodiments, as compared with the protecting structure that the protecting member 15 such as the lengthy corrugated tube, the tube and the vinyl sheet is usually provided over the plurality of interfering parts 13, the protecting members 15 are provided in the forms of spots respectively for the interfering parts 13. Accordingly, the part of an unnecessary corrugated tube, a tube and a vinyl sheet provided only for connecting the interfering parts together is eliminated, so that a quantity and kinds (kinds of different lengths) of the protecting members 15 can be suppressed to a minimum as necessary as possible. Namely, the protecting member 15 can be reduced more by the quantity of the parts of the unnecessary corrugated tube, the tube and the vinyl sheet to be eliminated. Further, when one kind of the protecting member 15 used in the forms of spots is merely provided, the plurality of interfering parts 13 located at various pitches can be individually met. Thus, a plurality of kinds of corrugated tubes, tubes and vinyl sheets having the different lengths for protecting the interfering parts together do not need to be prepared.

Accordingly, in the wire harness protecting structure according to the present exemplary embodiment, the protecting members 15 are provided in the forms of spots respectively for the interfering parts 13. Thus, the quantity and kinds of the protecting members 15 can be suppressed and reduced to a minimum as necessary as possible, and a cost can be lowered. Further, an entire part of the wire harness can be lightened.

The present invention is not limited to the above-described exemplary embodiments, respectively and may be suitably modified and improved. Further, members, forms, dimensions, configurations, quantities, arranged positions or the like of the structures of the present invention are respectively arbitrary as long as the object of the present invention can be achieved and are not limited to the above-described exemplary embodiments.

The present invention is described in detail or by referring to the specific exemplary embodiments, however, it is to be understood to a person with ordinary skill in the art that various changes or modifications may be made without departing from the spirit and scope of the present invention.

This application is based on Japanese Patent Application (JPA No. 2010-161711) filed on Jul. 16, 2010 and contents thereof are incorporated herein as a reference.

### INDUSTRIAL APPLICABILITY

According to the wire harness protecting structure of the present invention, since the protecting members are provided in the forms of spots respectively for the interfering parts, the quantity and kinds of the protecting members can be suppressed and reduced to a minimum as necessary as possible, and a cost can be lowered. Further, an entire part of the wire harness can be lightened.

### DESCRIPTION OF REFERENCE NUMERALS AND SIGNS

11 . . . wire harness
13 . . . interfering part
15 . . . protecting member
17 . . . starting end part
19 . . . terminal end part
21 . . . fixing adhesive tape
23 . . . protecting adhesive tape

1. A wire harness protecting structure which protects a predetermined part of a wire harness from an interference of other member, comprising:
a protecting member which cover an outer periphery of the wire harness in the predetermined part; and
a fixing adhesive tape in which a starting end part thereof is wound and fixed on the wire harness, the fixing adhesive tape is wound on the outer periphery of the protecting member so as to fix the protecting member, and then, a terminal end part thereof is wound and fixed on the wire harness in an opposite side to the starting end part with the protecting member sandwiched between the starting end part and the terminal end part.

2. The wire harness protecting structure according to claim 1, wherein the protecting member is respectively provided at plurality of predetermined parts.

3. The wire harness protecting structure according to claim 1, wherein the protecting member is formed with a protecting adhesive tape.

4. The wire harness protecting structure according to claim 3, wherein the protecting adhesive tape is thicker than the fixing adhesive tape.

5. The wire harness protecting structure according to claim 3, wherein the protecting adhesive tape has a plurality of tapes laminated.

6. The wire harness protecting structure according to claim 4, wherein the protecting adhesive tape has a plurality of tapes laminated.
